(19) United States
(12) Patent Application Publication
(10) Pub. No.: US 2014/0132617 A1
(43) Pub. Date: May 15, 2014

(54) SIMULATION OF OIL PAINT ON A CANVAS

(71) Applicant: MICROSOFT CORPORATION, Redmond, WA (US)

(72) Inventors: Subha Bhattacharyay, Medina, WA (US); Gerard Zytnicki, Seattle, WA (US); Jeffrey Alan Herold, Kirkland, WA (US); Christopher Shannon Lester, Redmond, WA (US); Ira Lynn Snyder, JR., Bellevue, WA (US); Fan Zhang, Redmond, WA (US); Hans Thomas Landsberger, Greenwich, CT (US); John Adam Szofran, Seattle, WA (US); Kaushik Barat, Redmond, WA (US)

(73) Assignee: MICROSOFT CORPORATION, Redmond, WA (US)

(21) Appl. No.: 13/676,501

(22) Filed: Nov. 14, 2012

(51) Int. Cl. G06T 11/00

(52) U.S. Cl. CPC G06T 11/001
USPC 345/582

(57) ABSTRACT

Various technologies described herein pertain to simulating oil painting. Data can be received from a sensor that indicates a desired orientation of an image editing tool with respect to a computer-implemented canvas. The computer-implemented canvas can include a paint map, which includes color values and height values of pixels representative of oil paint deposited on the computer-implemented canvas. Moreover, a footprint of the image editing tool upon the computer-implemented canvas can be computed based upon the data from the sensor. Further, an oil paint ridge model can be generated by modulating height values of a subset of the pixels from the paint map that are outside the footprint and less than or equal to a predetermined distance from an edge of the footprint. A display screen of a computing device can be caused to update an image rendered thereupon based upon the oil paint ridge model.

### BACKGROUND

Artists have conventionally utilized brushes and paints to create a work of art on a canvas. An artist has the freedom to choose a type and size of canvas, a type and size of brush, and types and colors of paint to create a work of art. Different canvases, brushes, and paints can give the artist freedom in generating the work of art.

As computers have become more popular and readily accessible, paint simulation programs have been created that are configured to simulate artistic painting on a computer. These paint simulation programs have traditionally not been particularly robust or realistic. For example, many paint simulation programs utilize two-dimensional stamps of a fixed size and shape, such as a circle or square. A user can select the stamp, select the color, and then utilize an input device (e.g., a mouse or touchpad) to stamp the shape repeatedly on a computer screen in accordance with user input. It can be readily ascertained, however, that real-world paintbrushes have several degrees of freedom, such that the size and shape of a footprint of the paintbrush changes as the user handles the paintbrush.

More recently, traditional paint simulation programs have attempted to mimic use of physical media through various brushes and paint effects. For instance, in some paint simulation programs, the brushes can be styled to represent depositing various types of paint such as oils, acrylics, pastels, charcoals, pen or the like. Moreover, the paint simulation programs can provide various effects for each type of paint, which attempt to portray realistic effects for the differing types of paint. However, many of these conventional paint simulation programs commonly lack realistic modeling of paint interaction that resembles characteristics of physical painting on a physical canvas.

### SUMMARY

Described herein are various technologies that pertain to simulating oil painting. Data can be received from a sensor that indicates a desired orientation of an image editing tool with respect to a computer-implemented canvas. The computer-implemented canvas can include a paint map, which includes color values and height values of pixels representative of oil paint deposited on the computer-implemented canvas. Moreover, a footprint of the image editing tool upon the computer-implemented canvas can be computed based upon the data from the sensor. Further, an oil paint ridge model can be generated by modulating height values of a subset of the pixels from the paint map that are outside the footprint and less than or equal to a predetermined distance from an edge of the footprint. A display screen of a computing device can be caused to update an image rendered thereupon based upon the oil paint ridge model.

In accordance with various embodiments, oil paint deposited on the computer-implemented canvas can be dried. For instance, the paint map of the computer-implemented canvas can include a wet layer and a dry layer. The oil paint deposited on the computer-implemented canvas can be dried by merging the wet layer into the dry layer to create an updated dry layer. Merging the wet layer into the dry layer can include combining height values from the wet layer and the dry layer per pixel in the updated dry layer. Further, merging the wet layer into the dry layer can include replacing color values from the dry layer with color values from the wet layer in the updated dry layer for pixels having color values in the wet layer. Moreover, merging the wet layer into the dry layer can include maintaining color values from the dry layer in the updated dry layer for pixels lacking color values in the wet layer.

According to various embodiments set forth herein, the footprint of the image editing tool upon the computer-implemented canvas can be computed based at least in part upon geometry of an image editing tool specified by a model of the image editing tool, the data received from the sensor that indicates a desired orientation of the image editing tool with respect to the computer-implemented canvas, and the height values of the pixels from the paint map. The footprint can further be computed based upon a texture of the computer-implemented canvas. Moreover, the footprint can be computed based upon data received from the sensor that indicates a pressure applied to the image editing tool. The footprint can further be computed based upon data received from the sensor that indicates movement of the image editing tool.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates a functional block diagram of an exemplary system that facilitates simulating artistic painting utilizing a computing device.

FIG. 2 illustrates a functional block diagram of an exemplary system that facilitates simulating real-world artistic painting/image editing.

FIG. 3 illustrates a functional block diagram of an exemplary effector component from the system of FIG. 2 in greater detail.

FIG. 4 illustrates a functional block diagram of an exemplary paint component of the system of FIG. 2 in greater detail.

FIG. 5 illustrates an exemplary side view of oil paint deposited on a paint surface depicting a ridge effect.

FIGS. 6-7 illustrate an exemplary scenario where height values of a subset of pixels in a paint map outside a footprint are modulated based upon respective distances from an edge of the footprint to simulate the ridge effect shown in FIG. 5.

FIG. 8 illustrates an exemplary graph depicting three directions from a pixel that can be evaluated when detecting an edge of a footprint.

FIG. 9 illustrates an exemplary computer-implemented canvas.

FIGS. 10-12 illustrate an exemplary graphical depiction of oil paint drying in accordance with various aspects described herein.

FIG. 13 is a flow diagram that illustrates an exemplary methodology of simulating oil painting.

FIG. 14 is a flow diagram that illustrates an exemplary methodology of drying oil paint deposited on a computer-implemented canvas by merging a wet layer into a dry layer of a paint map to create an updated dry layer.

FIG. 15 illustrates an exemplary computing device.

### DETAILED DESCRIPTION

Various technologies pertaining to simulation of painting with oil paint on a computer-implemented canvas are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As set forth herein, painting with oil paint on a computer-implemented canvas is simulated. Fluid flow and interaction of oil paint can be modeled to provide dynamism to the oil paint. Accordingly, oil paint previously deposited on the computer-implemented canvas can be manipulated to enhance dynamism of the oil paint. For instance, an oil paint ridge model can be generated by modulating height values of a subset of pixels from a paint map that are outside a footprint of an image editing tool. Moreover, the oil paint deposited on the computer-implemented canvas can have various states of dryness. Further, the oil paint deposited on the computer-implemented canvas can have a three-dimensional height (e.g., height value for the pixels in the paint map), which can effect subsequent painting operations.

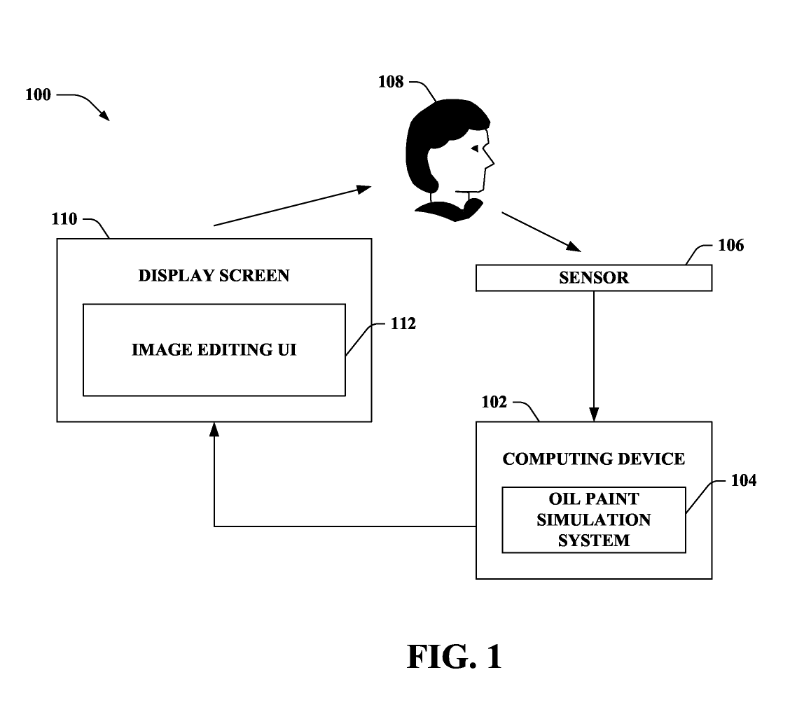

Referring now to the drawings, FIG. 1 illustrates a system 100 that facilitates simulating artistic painting utilizing a computing device 102. The system 100 includes the computing device 102, which further comprises an oil paint simulation system 104. The system 100 also includes a sensor 106 that is configured to receive input data from a user 108. The user 108 can utilize substantially any input mechanism, where the sensor 106 is configured to sense movement and/or position of such input mechanism. Examples of the input mechanism that can be employed by the user 108 include, but are not limited to, a finger (or fingers) of the user 108, a hand (or hands) of the user 108, a stylus, a combination thereof, and so forth.

The sensor 106 can output data that is indicative of the movement and/or position of the input mechanism, and such data can be received by the computing device 102. A display screen 110 can be in communication with the computing device 102, such that the computing device 102 can cause the display screen 110 to display graphical data. More particularly, the oil paint simulation system 104 can be configured to cause the display screen 110 to display an image editing user interface (UI) 112. The image editing UI 112 can include a graphical depiction of a canvas, paint selections such that the user 108 can select a type and/or color of paint to employ, image editing tool (e.g., brush) selections such that the user 108 can select a type and/or size of image editing tool to employ, amongst other graphical data. Thus, the oil paint simulation system 104 is configured to provide a computer-implemented simulation environment, wherein images caused to be displayed in the image editing UI 112 are based at least in part upon input data detected by the sensor 106.

It is contemplated that the sensor 106 can be substantially any type of sensor that can accept input from the user 108. For example, the sensor 106 can be a gesture enabled trackpad, touch sensitive display screen (e.g., the sensor 106 can be integrated into the display screen 110), mouse, camera, microphone, remote control, keyboard, combination thereof, or the like. According to various examples, it is contemplated that the sensor 106 can rely on speech recognition, touch and stylus recognition, gesture recognition both on the display screen 110 and adjacent to the display screen 110, air gestures, head and eye tracking, voice and speech, vision, touch, gestures and the like. Moreover, the sensor 106 can be configured to output data that indicates position and/or movement. The output data can be utilized by the oil paint simulation system 104, which can cause images to be displayed in the image editing UI 112 that are reflective of an artistic intent of the user 108.

In accordance with an example, the sensor 106 can be a gesture enabled trackpad. Following this example, the gesture enabled trackpad can output data that indicates position and/or movement of a finger (or fingers) of the user 108, including height field(s) corresponding to the finger (or fingers) of the user 108. Such data can be indicative of movement of a paintbrush or other suitable image editing tool over a computer-implemented canvas. Additionally or alternatively, the gesture enabled trackpad can output data that specifies pressure applied by the finger (or fingers) of the user 108. The oil paint simulation system 104 can obtain such data and cause updated images to be displayed in the image editing UI 112 on the display screen 110.

By way of another example, the sensor 106 can be a mouse. Following this example, through movement of the mouse and selection of one or more buttons on the mouse, the user 108 can cause the mouse to output data that is indicative of movement of a paintbrush or other suitable image editing tool over the computer-implemented canvas. The oil paint simulation system 104 can receive such data and can cause updated images to be displayed in the image editing UI 112 on the display screen 110.

According to a further example, the sensor 106 can be integrated into the display screen 110, such that the display screen 110 is a touch sensitive display screen. The user 108 can move his finger (or fingers) or stylus over the display screen 110 as if the user 108 were painting on a canvas. The oil paint simulation system 104 can cause the image editing UI 112 to update images on the computer display screen 110 based at least in part upon sensed movement of the finger (or fingers) of the user 108 or stylus utilized by the user 108 over the display screen 110.

While several examples have been set forth above, it is to be understood that the oil paint simulation system 104 can be configured to simulate real-world artistic painting/image editing based at least in part upon any suitable input device that is representative of position/movement of a three-dimensional image editing tool (e.g., paintbrush, etc.) over a canvas. For instance, the sensor 106 can be configured to detect orientation of an input mechanism (e.g., in three-dimensions), pressure applied by the user 108 with respect thereto, amongst other data that is indicative of intent of the user 108 with respect to painting on a canvas. Operation of the oil paint simulation system 104 will now be described in greater detail below.

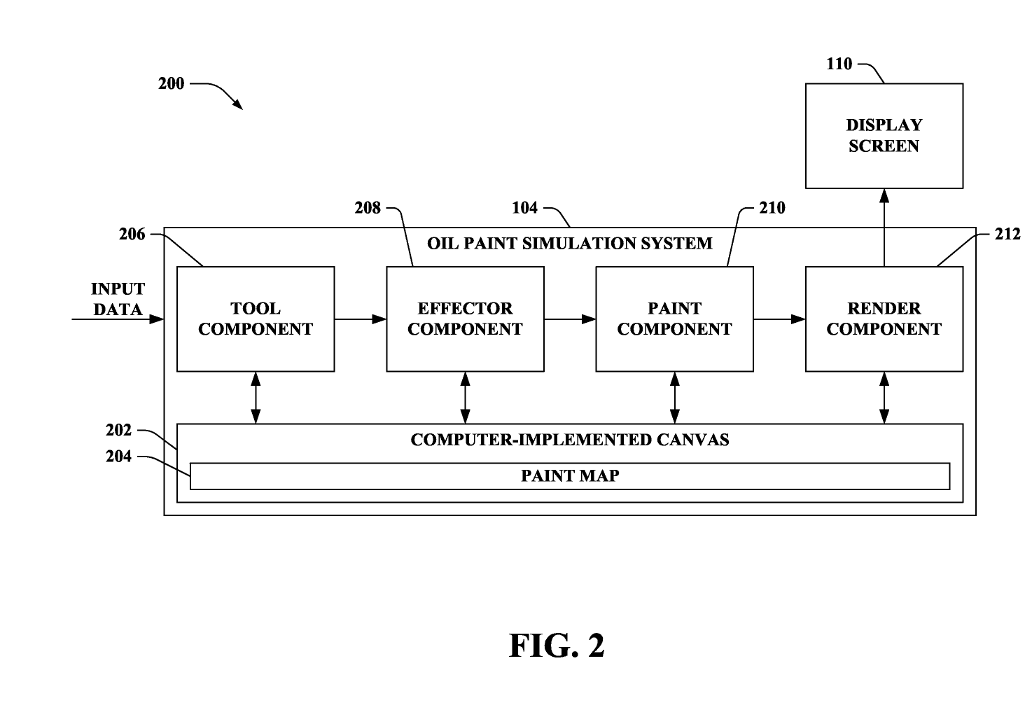

Now turning to FIG. 2, illustrated is a system 200 that facilitates simulating real-world artistic painting/image editing. The system 200 includes the oil paint simulation system 104 and the display screen 110. As indicated above, the oil paint simulation system 104 receives input data from a sensor (e.g., the sensor 106 of FIG. 1). The input data can be indicative of a desired orientation of an image editing tool with respect to a computer-implemented canvas 202. The input data can also include an indication of type and/or color of paint desirably applied to the computer-implemented canvas 202 by the image editing tool, type and/or size of the computer-implemented canvas 202, type and/or size of the image editing tool, pressure applied to the image editing tool, a combination thereof, and so forth.

The computer-implemented canvas 202 can have various properties. Examples of the properties include texture (e.g., surface ridges), absorption, color, and the like. According to an illustration, a type of medium (e.g., type of paper, etc.) for the computer-implemented canvas 202 can be selected by the user, and the selected medium type can have a set of properties (e.g., texture, absorption, color, etc.). By way of another illustration, it is contemplated that the computer-implemented canvas 202 can be a still image (e.g., selected by a user, captured by a camera, etc.). The computer-implemented canvas 202 further includes a paint map 204. The paint map 204 includes color values and height values of pixels representative of oil paint deposited on the computer-implemented canvas 202. The height values of the pixels in the paint map 204 can enhance realism by providing a thickness to the oil paint deposited on the computer-implemented canvas 202, which can be visually observable when rendered on the display screen 110 and can effect subsequent painting operations.

Moreover, the oil paint simulation system 104 includes a tool component 206 that generates a model of the image editing tool. The model of the image editing tool can specify geometry of the image editing tool. For instance, the image editing tool can be a paintbrush; however, the claimed subject matter is not so limited. The model of the image editing tool generated by the tool component 206 can be based at least in part upon the input data from the user (e.g., the input data from the user can indicate a selection of the type and/or size of the image editing tool).

The tool component 206 can provide rendering algorithms for various image editing tools that are selectable responsive to the input data received from the user. For instance, image editing tools can be provided for oil, pastels, custom paint tools, and the like. Further, the tool component 206 can initiate simulation and/or rendering of paint on the computer-implemented canvas 202. The tool component 206 can also initiate rendering of the image editing tool, including deformations of the brush bristles, etc. For instance, each image editing tool provided by the tool component 206 can have properties that define rendering of such image editing tool on the display screen 110. The tool component 206 can cause the image editing tool to be rendered in real-time as such image editing tool is being used. Thus, the tool component 206 can cause the image editing tool to be rendered per properties of such image editing tool and the received input data. Moreover, the tool component 206 can update the image editing tool over time.

The oil paint simulation system 104 further includes an effector component 208 that computes a footprint of the image editing tool upon the computer-implemented canvas 202 based at least in part upon the geometry of the image editing tool and the input data received from the user. The footprint of the image editing tool can further be computed by the effector component 208 based upon texture of the computer-implemented canvas 202, height values of the pixels specified in the paint map 204, a combination thereof, and so forth. Moreover, the tool component 206 can instantiate the effector component 208 (or a plurality of effector components similar to the effector component 208).

The oil paint simulation system 104 can further include a paint component 210 that can update the pixels from the paint map 204 within the footprint based at least in part upon the color values and the height values of the pixels within the footprint as specified in the paint map 204 as well as a pickup map. The pickup map can include color values and height values representative of a disparate oil paint on the image editing tool. The pixels from the paint map 204 within the footprint can be updated by the paint component 210 to deposit the disparate oil paint from the image editing tool onto the computer-implemented canvas 202. Such deposition of the disparate oil paint can be effectuated by mixing (e.g., through linear interpolation, etc.) the disparate oil paint from the image editing tool (e.g., represented by the color values and height values from the pickup map) with the oil paint previously deposited on the computer-implemented canvas 202 (e.g., represented by the color values and height values from the paint map 204).

The paint component 210 can include logic to simulate and render oil paint on the computer-implemented canvas 202. For instance, the paint component 210 can provide paint simulation algorithms. Moreover, the paint component 210 can include shaders. Further, it is contemplated that the paint component 210 can continuously update the image rendered on the display screen 110 (e.g., to animate painting, etc.).

The oil paint simulation system 104 can also include a render component 212 that is configured to render an artistic work on the computer-implemented canvas 202 displayed on the display screen 110. The render component 212 can utilize any suitable rendering technique to render the artistic work on the display screen 110. Moreover, the render component 212 can be configured to render paint such that it appears as a thin layer on the display screen 110, control glossiness of paint as it appears on the display screen 110, control lighting and/or height of paint as it appears on the display screen 110, etc.

As noted above, it is contemplated that the tool component 206 can instantiate multiple effector components similar to the effector component 208. For instance, multiple effector components can be instantiated by the tool component 206 when using the image editing tool to paint by sprinkling the oil paint on the computer-implemented canvas 202 or airbrushing the oil paint on the computer-implemented canvas 202. Thus, each paint drop can be considered as a source with a respective footprint, where the respective footprints can be computed by differing effector components. According to an example, the tool component 206 can instantiate two effector components. Following this example, the first effector component can compute a first footprint of the image editing tool upon the computer-implemented canvas 202, and the second effector component can compute a second footprint of the image editing tool upon the computer-implemented canvas 202. Such effector components can compute the footprints based at least in part upon the data received from the sensor. Accordingly, the paint component 210 can deposit disparate oil paint from the image editing tool onto the computer-implemented canvas 202 by updating pixels from the paint map 204 within the first footprint and the second footprint based at least in part upon the color values and the height values of the pixels within the first footprint and the second footprint and the pickup map. Again, the pickup map can include color values and height values representative of the disparate oil paint on the image editing tool. It is to be appreciated, however, that the claimed subject matter is not limited to the foregoing example as it is contemplated that substantially any number of effector components can be instantiated by the tool component 206.

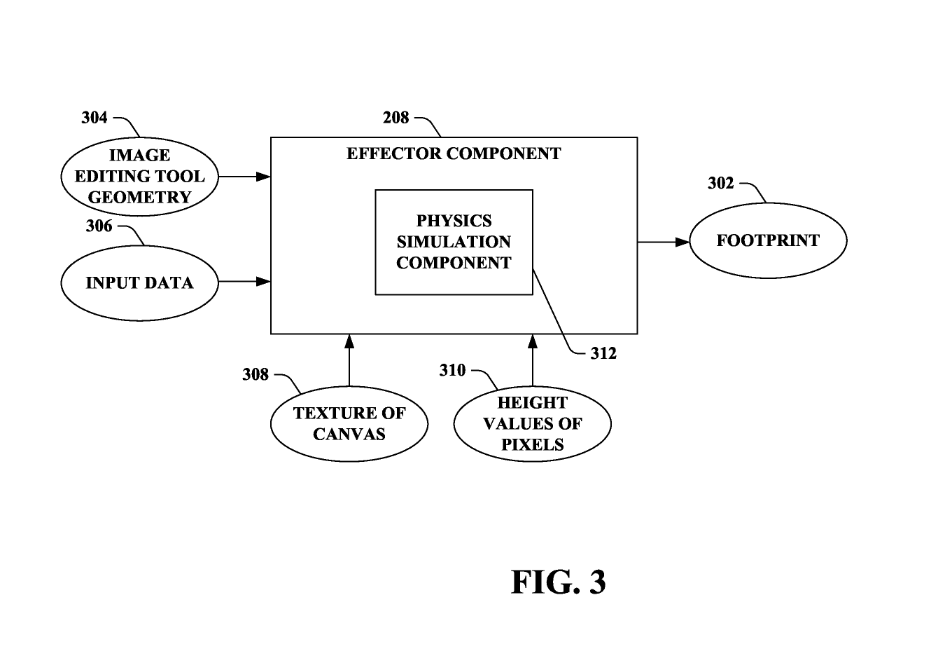

Turning now to FIG. 3, illustrated is the effector component 208 in greater detail. As noted above, the effector component 208 computes a footprint 302 of an image editing tool upon a computer-implemented canvas (e.g., the computer-implemented canvas 202 of FIG. 2). The effector component 208 can compute the footprint 302 of the image editing tool upon the computer-implemented canvas based upon geometry of the image editing tool 304. Moreover, the effector component 208 can compute the footprint 302 of the image editing tool upon the computer-implemented canvas based upon input data 306. The input data 306, for instance, can be data received from the sensor (e.g., the sensor 106 of FIG. 1) that indicates a desired orientation of the image editing tool 304 with respect to the computer-implemented canvas, data received from the sensor that indicates a pressure applied to the image editing tool, data received from the sensor that indicates movement of the image editing tool, and so forth. Moreover, the effector component 208 can compute the footprint 302 of the image editing tool upon the computer-implemented canvas based on a texture of the computer-implemented canvas 308. Further, the effector component 208 can compute the footprint 302 of the image editing tool upon the computer-implemented canvas based upon height values of the pixels from the paint map 310 (e.g., from the paint map 204 of FIG. 2). It is contemplated that the aforementioned parameters or a subset thereof can be utilized by the effector component 208 to compute the footprint 302 of the image editing tool of upon the computer-implemented canvas.

Moreover, the effector component 208 can include a physics simulation component 312 that simulates physics of the interaction between the image editing tool and the computer-implemented canvas when computing the footprint 302. For instance, if the image editing tool is a brush tuft, then the physics simulation component 312 can provide for deformation of such brush. According to another example, if the image editing tool is a paint drop, then the physics simulation component 312 can simulate the physics of such paint drop as though it is thrown through the air onto the computer-implemented canvas, slides on a paint surface, etc. Yet, it is to be appreciated that the claimed subject matter is not limited to the foregoing examples.

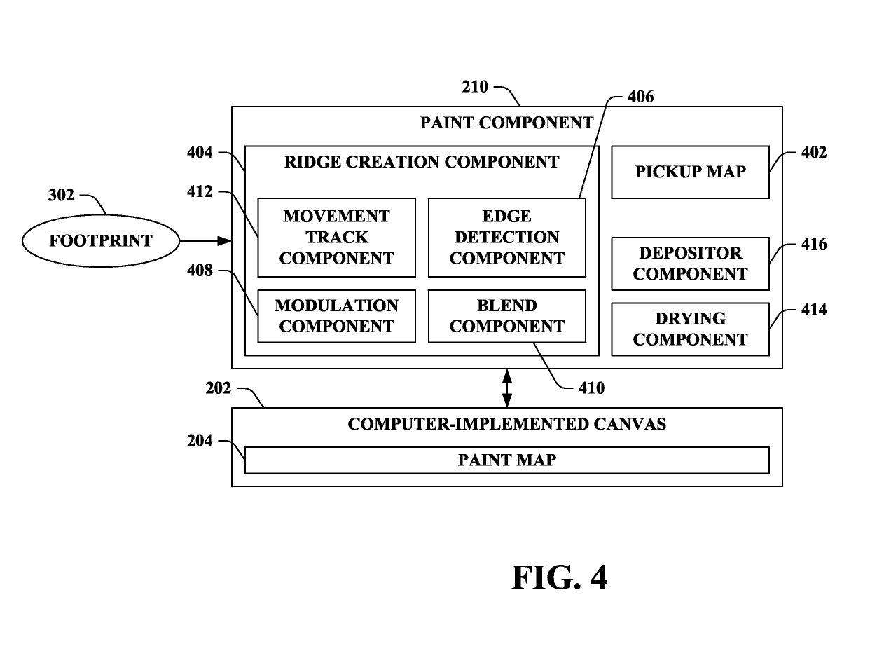

With reference to FIG. 4, the paint component 210 is described in greater detail. The paint component 210 can include a depositor component 416 that deposits oil paint from the image editing tool onto the computer-implemented canvas 202. More particularly, the depositor component 416 can update the pixels from the paint map 204 within the footprint 302 based at least in part upon the color values of the pixels within the footprint 302 and a pickup map 402. The pickup map 402 can include color values and height values representative of oil paint on the image editing tool. Thus, the depositor component 416 can update the pixels to deposit the oil paint from the image editing tool onto the computer-implemented canvas 202.

Moreover, the paint component 210 includes a ridge creation component 404 that generates an oil paint rigid model. The ridge creation component 404 can model fluid flow and interaction to allow the user to create rich artwork that resembles physical painting. When physically pushing oil paint, a ridge is often observed. For example, when physically painting on wet oil paint, the oil paint underneath a brush can be pushed towards the sides of the brush during a brush stroke, and the oil paint pushed away can pile up around a footprint, resulting in a ridge that can remain after the brush stroke. Such ridge can be modeled by the ridge creation component 404 to simulate dynamism of depositing oil paint and interacting with previously deposited oil paint.

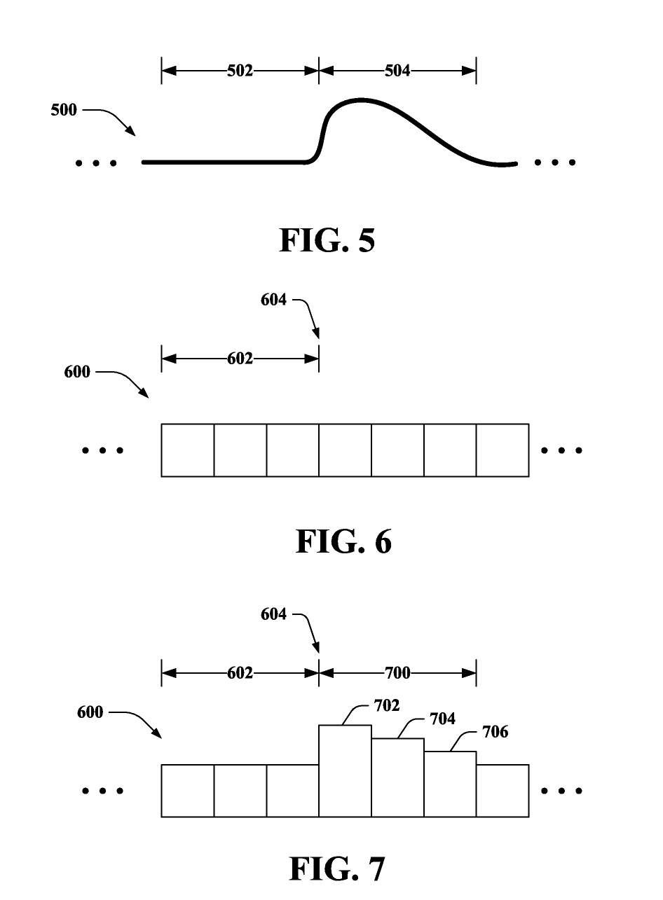

Turning briefly to FIG. 5, illustrated is an exemplary side view of oil paint 500 deposited on a paint surface (e.g., a canvas). The oil paint 500 can be deposited on the paint surface due to a brush stroke of a paintbrush that moves in a direction from left to right. The paintbrush forms a footprint 502 and a ridge 504, which is at the right side of the footprint 502 (e.g., ahead of the footprint 502 in the direction of movement of the paintbrush). During the brush stroke, the paintbrush pushes previously deposited oil paint from the paint surface towards a leading edge of the footprint 502 (e.g., in the direction of movement of the paintbrush), which forms the ridge 504 outside the footprint 502. Such ridge 504 formed along the edge of the footprint 502 can be modeled by the ridge creation component 404 of FIG. 4.

Again reference is made to FIG. 4. The ridge creation component 404 can generate the oil paint ridge model. More particularly, the ridge creation component 404 includes an edge detection component 406 that identifies a subset of the pixels from the paint map 204 that are outside the footprint 302 and less than or equal to a predefined distance from an edge of the footprint 302. Moreover, the ridge creation component 404 includes a modulation component 408 that modulates the height values of the subset of the pixels from the paint map 204. Accordingly, the display screen of the computing device can be caused to update the image rendered thereupon based at least in part upon the oil paint rigid model generated by the ridge creation component 404.

According to an example, the predefined distance from the edge of the footprint 302 can be three pixels. Many of the examples set forth herein describe the predefined distance being three pixels; however, it is to be appreciated that other predefined distances from the edge of the footprint 302 are intended to fall within the scope of the hereto appended claims. For instance, predefined distances of one pixel, two pixels, four pixels, five pixels, or more than five pixels are intended to fall within the scope of the hereto appended claims.

The edge detection component 406 can determine respective distances of the subset of the pixels from the edge of the footprint 302. Moreover, the modulation component 408 can modulate the height values of the subset of the pixels as a function of the respective distances from the edge of the footprint 302. According to an example, the modulation component 408 can increase a first height value of a first pixel in the subset by a first increment, where the first pixel is at a distance of one pixel from the edge of the footprint 302 as determined by the edge detection component 406. Following this example, the modulation component 408 can increase a second height value of a second pixel in the subset by a second increment, where the second pixel is at a distance of two pixels from the edge of the footprint 302 as determined by the edge detection component 406, and where the first increment is greater than the second increment. Further following this example, the modulation component 408 can increase a third height value of a third pixel in the subset by a third increment, where the third pixel is at a distance of three pixels from the edge of the footprint 302 as determined by the edge detection component 406, and where the second increment is greater than the third increment.

With reference to FIGS. 6-7, illustrated is an exemplary scenario where height values of a subset of pixels in a paint map 600 (e.g., the paint map 204) outside a footprint 602 (e.g., the footprint 302) are modulated based upon respective distances from an edge 604 of the footprint 602 to simulate the ridge effect shown in FIG. 5. It is to be appreciated that the example set forth in FIGS. 6-7 is provided for illustration purposes, and the claimed subject matter is not so limited.

FIG. 6 illustrates pixel height values prior to the modulation component 408 increasing the height values of pixels in the paint map 600 outside of the footprint 602 within a predefined distance from the edge 604 of the footprint 602. Similar to the example shown in FIG. 5, the footprint 602 can be moving in a direction from left to right.

Turning to FIG. 7, a subset of pixels 700 from the paint map 600 that are outside the footprint 602 and less than or equal to a predefined distance from the edge 604 of the footprint 602 can be identified. In the depicted example, the predefined distance is three pixels. Accordingly, the subset of pixels 700 includes a pixel 702, a pixel 704, and a pixel 706. Further, heights values of the pixel 702, the pixel 704, and the pixel 706 (e.g., the height values specified in the paint map 600 as shown in FIG. 6) are modulated by respective increments as a function of respective distances from the edge 604 of the footprint 602. As illustrated, a height value of the pixel 702 is increased by a first increment, a height value of the pixel 704 is increased by a second increment, and a height value of the pixel 706 is increased by a third increment, where the first increment is greater than the second increment, and the second increment is greater than the third increment.

Reference is again made to FIG. 4. The ridge creation component 404 can further include a blend component 410 that mixes a color value of a pixel in the subset of pixels from the paint map 204 with a footprint color value. The blend component 410 can employ linear interpolation to mix such color values. For example, the blend component 410 can mix color values for pixels that are at a distance of one pixel from the edge of the footprint 302. However, according to other examples, it is to be appreciated that pixels at a distance of more than one pixel from the edge of the footprint 302 can have colors mixed by the blend component 410, and the claimed subject matter is not limited to the foregoing example.

Moreover, the ridge creation component 404 can include a movement track component 412 that computes a movement direction of the footprint 302. The subset of the pixels from the paint map 204 identified by the edge detection component 406 and modulated by the modulation component 408 can further be a function of the movement direction of the footprint 302 computed by the movement track component 412. Thus, a ridge can be formed ahead of a leading edge of the footprint 302 as the footprint 302 moves across the computer-implemented canvas 202. By way of example, it is contemplated that a ridge can be formed around the footprint 302 if the footprint 302 is formed based upon a drop of paint being splattered onto the computer-implemented canvas 202 (e.g., the movement direction of the footprint 302 can be considered to be in a direction into the computer-implemented canvas 202 by the movement track component 412); yet, the claimed subject matter is not so limited.

The following example illustrates operation of the ridge creation component 404. The ridge creation component 404 can obtain the footprint 302. Around the edge of the footprint 302, the ridge creation component 404 can modify color values and height values of a subset of pixels in the paint map 204 to simulate the ridge effect. More particularly, a height value and/or a color value of a current pixel (e.g., a pixel from the paint map 204) can be modified at least as a function of a distance from the edge of the footprint 302 determined by the edge detection component 406 as set forth below.

Pursuant to this example, if the edge detection component 406 determines that the current pixel is a level one edge (e.g., the current pixel is at a distance of one pixel from the edge of the footprint 302), then the ridge creation component 404 can evaluate whether the current pixel has paint in the paint map 204. If the current pixel is determined to lack paint in the paint map 204, then the blend component 410 can set a color value of the current pixel to a color value from the footprint and the modulation component 408 can linearly interpolate a height value for the current pixel. Alternatively, if the ridge creation component 404 determines that the current pixel includes paint in the paint map 204, then the modulation component 408 can increase the height value for the current pixel specified in the paint map 204 by a first increment. For instance, the first increment can be 0.06, and a maximum height value can be a footprint height plus 0.4; yet, the claimed subject matter is not so limited. Moreover, the blend component 410 can mix the footprint color with the color value of the current pixel specified in the paint map 204 when the current pixel is determined to include paint in the paint map 204.

Further following the aforementioned example, if the edge detection component 406 determines that the current pixel is a level two edge (e.g., the current pixel is at a distance of two pixels from the edge of the footprint 302), then the ridge creation component 404 can evaluate whether the current pixel has paint in the paint map 204. If the current pixel is determined to lack paint in the paint map 204, then the blend component 410 can set a color value of the current pixel to a color value from the footprint 302 and the modulation component 408 can linearly interpolate a height value for the current pixel. Alternatively, if the ridge creation component 404 determines that the current pixel includes paint in the paint map 204, then the modulation component 408 can increase the height value of the current pixel specified in the paint map 204 by a second increment. For instance, the second increment can be 0.04, and a maximum height value can be a footprint height plus 0.2; however, it is to be appreciated that the claimed subject matter is not so limited. Further, the blend component 410 need not change the color for the current pixel as specified in the paint map 204 when the current pixel is determined to include paint in the paint map 204.

Moreover, in accordance with the continuing example, if the edge detection component 406 determines that the current pixel is a level three edge (e.g., the current pixel is at a distance of three pixels from the edge of the footprint 302), then the ridge creation component 404 can evaluate whether the current pixel has paint in the paint map 204. If the current pixel is determined to lack paint in the paint map 204, then the blend component 410 can set a color value of the current pixel to a color value from the footprint 302 and the modulation component 408 can linearly interpolate a height value for the current pixel. Alternatively, if the ridge creation component 404 determines that the current pixel includes paint in the paint map 204, then the modulation component 408 can increase the height value of the current pixel as specified in the paint map 204 by a third increment. The third increment can be 0.02, and a maximum height value can be a footprint height plus 0.1, for instance; yet, the claimed subject matter is not so limited. Further, the blend component 410 can be inhibited from changing the color value of the current pixel in the paint map 204 when the current pixel is determined to include paint in the paint map 204. It is to be appreciated, however, that the claimed subject matter is not limited to the foregoing example.

As noted above, the movement track component 412 can compute a movement direction of the footprint 302. The movement direction of the footprint 302 can be employed by the edge detection component 406 to mitigate an impact on performance associated with detecting an edge of the footprint 302. For example, the edge detection component 406 can evaluate three directions from a pixel when determining whether the pixel is less than or equal to the predefined distance from the edge of the footprint 302 as opposed to checking a full circular range around the pixel. By way of example, the modulation component 408 can modulate a height value of a pixel that is outside the footprint 302 if and only if the pixel is less than or equal to the predefined distance from the edge of the footprint 302 as determined by the edge detection component 406 in at least one of a first direction opposite the movement direction of the footprint 302 as determined by the movement track component 412, a second direction that is rotated clockwise by a predefined angle from the first direction, or a third direction that is rotated counterclockwise by the predefined angle from the first direction.

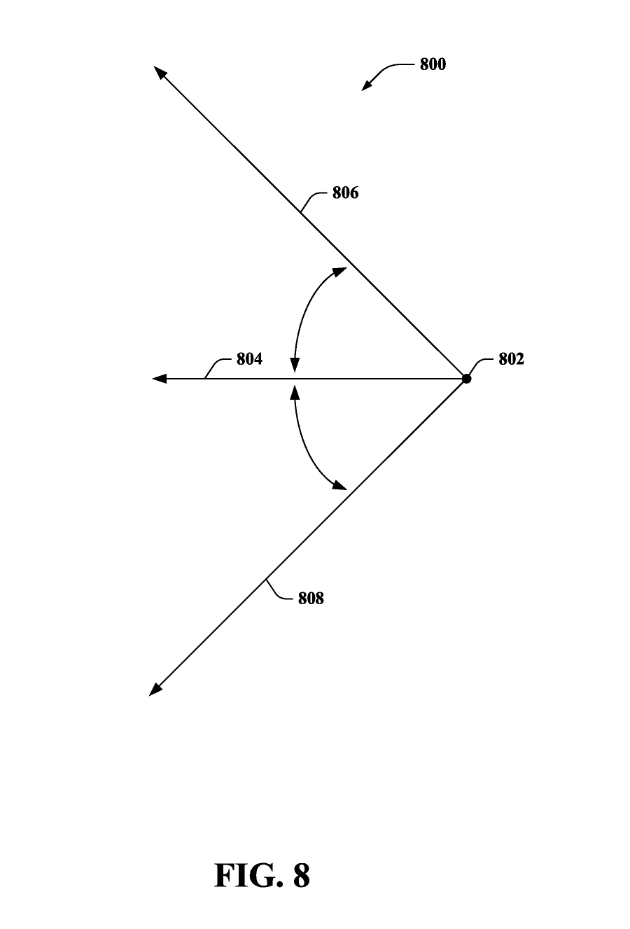

FIG. 8 illustrates an exemplary graph 800 depicting the three directions from a pixel 802 that can be evaluated by the edge detection component 406 of FIG. 4. As shown, the three directions include a first direction 804, a second direction 806, and a third direction 808. The first direction 804 is opposite a movement direction of a footprint (e.g., the movement direction of the footprint 302 as determined by the movement track component 412 of FIG. 4). The second direction 806 is rotated clockwise by a predefined angle from the first direction 804, and the third direction 808 is rotated counterclockwise by the predefined angle from the first direction 804. According to an example, the predefined angle can be 45°; however, the claimed subject matter is not so limited as other angles are intended to fall within the scope of the hereto appended claims. Moreover, while three directions are described, it is contemplated that substantially any other number of directions from the pixel 802 can be employed, and the claimed subject matter is not limited to employing three directions.

Reference is again made to FIG. 4. The edge detection component 406 can further check for an edge of the footprint 302 within a limited section of the computer-implemented canvas 202. More particularly, the edge detection component 406 can identify a bounding box of the footprint 302. The edge detection component 406 can determine whether pixels within the bounding box are outside the footprint 302 and less than or equal to the predefined distance from the edge of the footprint 302. Thus, the subset of the pixels for which the height values from the paint map 204 that are modulated by the modulation component 408 can be the pixels that are within the bounding box, outside the footprint 302, and less than or equal to the predefined distance from the edge of the footprint 302. Moreover, the edge detection component 406 can inhibit determining whether pixels outside the bounding box are outside the footprint 302 and less than or equal to the predetermined predefined distance from the edge of the footprint 302. Accordingly, less impact on performance can result from employing the bounding box, as each pixel in the paint map 204 need not be checked. Rather, a limited search area can be analyzed by the edge detection component 406, where pixels inside the bounding box of the footprint 302 are evaluated.

By way of another example, the ridge creation component 404 can inhibit processing the ridge effect when the movement track component 412 detects that the footprint 302 is moving at a speed above a threshold. For instance, when the speed is above the threshold, the oil paint ridge model can be inhibited from being generated; alternatively, when the speed is below the threshold, the oil paint ridge model can be generated by the ridge creation component 404. Yet, it is to be appreciated that the claimed subject matter is not limited to the foregoing example.

In accordance with yet a further example, the movement track component 412 can filter redundant move input data. By way of illustration, in a brush stroke, oftentimes move input data can indicate that a move distance of zero occurred. The movement track component 412 can filter the input data with zero move distance, such that the ridge creation component 404 can be inhibited from generating the oil paint ridge model in response to such input data.

The paint component 210 further includes a drying component 414. The drying component 414 dries the oil paint deposited on the computer-implemented canvas 202. Thus, interaction between the oil paint deposited on the computer- implemented canvas 202 and subsequent oil paint deposits can be dependent upon a state of dryness of the oil paint deposited on the computer-implemented canvas 202 as controlled by the drying component 414. For instance, the ridge creation component 404 can form a ridge in wet oil paint deposited on the computer-implemented canvas 202 (e.g., manipulating such wet oil paint), while being inhibited from forming a ridge in dry oil paint. Moreover, wet oil paint deposited on the computer-implemented canvas 202 can be mixed with oil paint subsequently deposited with the image editing tool, while the subsequently deposited oil paint can be inhibited from being mixed with dry oil paint deposited on the computer-implemented canvas 202. Further, wet oil paint on the computer-implemented canvas 202 can be picked up onto the image editing tool (e.g., causing the pickup map to be altered), while dry oil paint on the computer-implemented canvas 202 can be inhibited from being picked up. While the foregoing examples describe two states of dryness (e.g., wet oil paint, dry oil paint), it is to be appreciated that more than two states of dryness can be employed in accordance with various embodiments.

The drying component 414 can dry the oil paint deposited on the computer-implemented canvas 202 in response to user input (e.g., user selection to dry the oil paint, etc.), for example. Additionally or alternatively, the drying component 414 can dry the oil paint deposited on the computer-implemented canvas 202 after a threshold length of time (e.g., subsequent to depositing the oil paint on the computer-implemented canvas 202). It is to be appreciated, however, that the claimed subject matter is not limited to the foregoing examples.

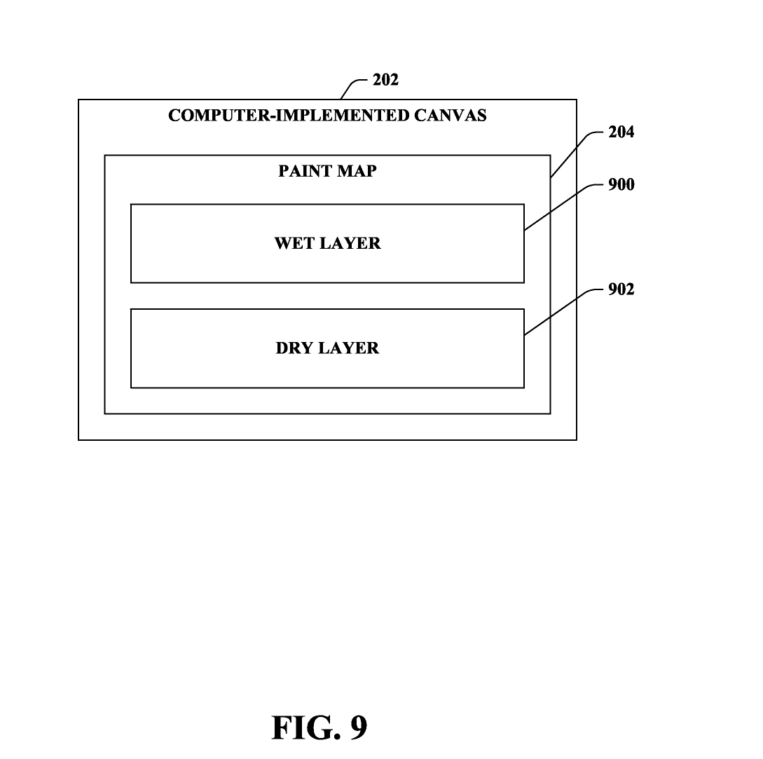

Turning to FIG. 9, illustrated is the computer-implemented canvas 202, which further includes the paint map 204. The paint map 204 includes a wet layer 900 and a dry layer 902. The wet layer 900 can be rendered above the dry layer 902 on the display screen.

With reference again to FIG. 4, the drying component 414 can dry the oil paint deposited on the computer-implemented canvas 202 by merging a wet layer (e.g., the wet layer 900 of FIG. 9) of the paint map 204 into a dry layer (e.g., the dry layer 902 of FIG. 9) of the paint map 204 to create an updated dry layer. Merging the wet layer of the paint map 204 into the dry layer of the paint map 204 can include combining height values from the wet layer and the dry layer per pixel in the updated dry layer. Moreover, merging the wet layer into the dry layer can include replacing color values from the dry layer with color values from the wet layer in the updated dry layer for pixels having color values in the wet layer. Further, merging the wet layer into the dry layer can include maintaining the color values from the dry layer in the updated dry layer for pixels lacking the color values in the wet layer.

It is further contemplated that disparate oil paint from the image editing tool can be deposited onto the computer-implemented canvas 202 subsequent to the drying component 414 drying the oil paint deposited on the computer-implemented canvas 202. The disparate oil paint can be deposited into the wet layer of the paint map 204 above the updated dry layer based at least in part upon the height values from the updated dry layer. Moreover, the display screen of the computing device can be caused to update an image rendered thereupon with the wet layer (e.g., including the disparate oil paint deposited subsequent to drying) covering the updated dry layer.

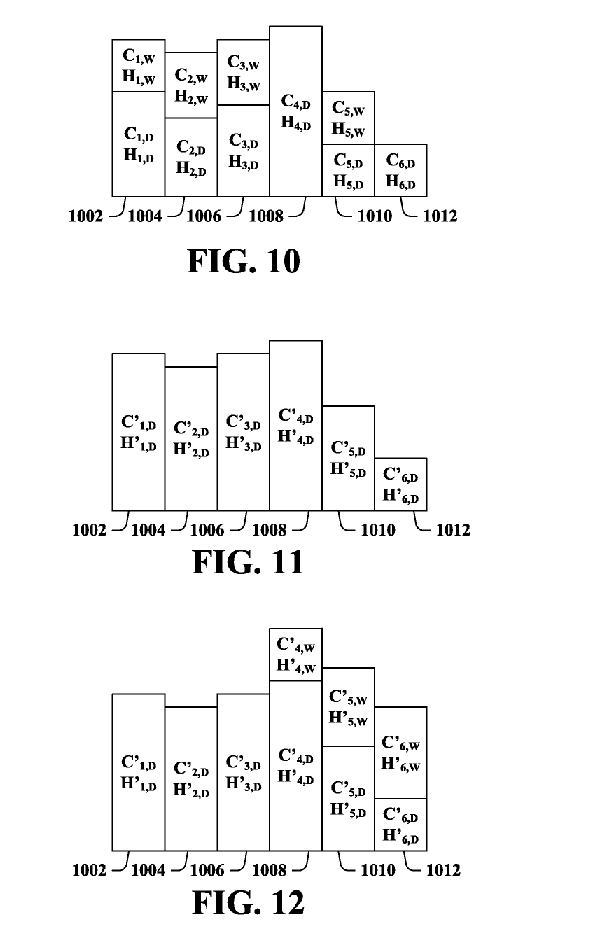

With reference to FIGS. 10-12, illustrated is an exemplary graphical depiction of oil paint drying (e.g., performed by the drying component 414 of FIG. 4) in accordance with various aspects described herein. FIGS. 10-12 represent a paint map that includes six pixels. The paint map includes a wet layer and a dry layer, where the wet layer is above the dry layer (e.g., the wet layer is rendered above the dry layer on a display screen). It is to be appreciated that the example set forth in FIGS. 10-12 is provided for illustration purposes, and the claimed subject matter is not limited to such example.

As shown in FIG. 10, the dry layer of the paint map includes color values and height values for the six pixels 1002-1012. A color value of the pixel 1002 in the dry layer is C_{1,D} and a height value of the pixel 1002 in the dry layer is H_{1,D}. A color value of the pixel 1004 in the dry layer is C_{2,D} and a height value of the pixel 1004 in the dry layer is H_{2,D}. A color value of the pixel 1006 in the dry layer is C_{3,D} and a height value of the pixel 1006 in the dry layer is H_{3,D}. A color value of the pixel 1008 in the dry layer is C_{4,D} and a height value of the pixel 1008 in the dry layer is H_{4,D}. A color value of the pixel 1010 in the dry layer is C_{5,D} and a height value of the pixel 1010 in the dry layer is H_{5,D}. A color value of the pixel 1012 in the dry layer is C_{6,D} and a height value of the pixel 1012 in the dry layer is H_{6,D}.

Moreover, as depicted in FIG. 10, the wet layer of the paint map includes color values and height values for four of the six pixels: namely, the pixel 1002, the pixel 1004, the pixel 1006, and the pixel 1010. A color value of the pixel 1002 in the wet layer is C_{1,W} and a height value of the pixel 1002 in the wet layer is H_{1,W}. A color value of the pixel 1004 in the wet layer is C_{2,W} and a height value of the pixel 1004 in the wet layer is H_{2,W}. A color value of the pixel 1006 in the wet layer is C_{3,W} and a height value of the pixel 1006 in the wet layer is H_{3,W}. A color value of the pixel 1010 in the wet layer is C_{5,W} and a height value of the pixel 1010 in the wet layer is H_{5,W}.

FIG. 11 illustrates drying of the oil paint represented by FIG. 10 by merging the wet layer into the dry layer. As illustrated, the height values from the wet layer and the dry layer are combined per pixel in FIG. 11. Thus, the height value of the pixel 1002 in the updated dry layer, H′_{1,D}, is computed by adding the height values of the pixel 1002 in the wet layer and dry layer from FIG. 10, C_{1,W} plus C_{1,D}. Moreover, the height values of the pixel 1004, the pixel 1006, and the pixel 1010 can similarly be computed. Further, since the pixel 1008 and the pixel 1012 lacked paint in the wet layer in FIG. 10, the height values of such pixels in the updated dry layer in FIG. 11 can be equal to the height values in the dry layer in FIG. 10. Moreover, the height values can be combined up to a maximum height for a given pixel, for example.

Further, the color values from the dry layer of FIG. 10 can be replaced with color values from the wet layer of FIG. 10 in the updated dry layer of FIG. 11 for the pixels having color values in the wet layer of FIG. 10. Thus, the color value from the dry layer of the pixel 1002, C_{1,D}, can be replaced by the color value from the wet layer of the pixel 1002, C_{1,W}, in the updated dry layer of FIG. 11 (e.g., C′_{1,D} can be changed to C_{1,W}). The color values of the pixel 1004, the pixel 1006, and the pixel 1010 can be similarly updated in FIG. 11 since such pixels include oil paint in the wet layer of FIG. 10.

Moreover, the color values from the dry layer of FIG. 10 can be maintained in the updated dry layer of FIG. 11 for the pixels lacking color values in the wet layer of FIG. 10. Hence, the color value from the dry layer of the pixel 1008, C_{4,D}, can be maintained in the updated dry layer of FIG. 11 (e.g., C′_{4,D} can be maintained as C_{4,D}). The color value of the pixel 1012 can be similarly maintained since such pixel lacks oil paint in the wet layer of FIG. 10.

FIG. 12 illustrates disparate oil paint being deposited into the wet layer above the updated dry layer of FIG. 11. More particularly, the disparate oil paint is deposited into the wet layer of the pixel 1008, the pixel 1010, and the pixel 1012. The height values of the pixels 1002-1012 from the update dry layer can impact depositing of the disparate oil paint (e.g., the footprint can be a function of such height values). However, color values of the pixels 1002-1012 from the updated dry layer can lack an impact on the depositing of the disparate oil paint into the wet layer in FIG. 12.

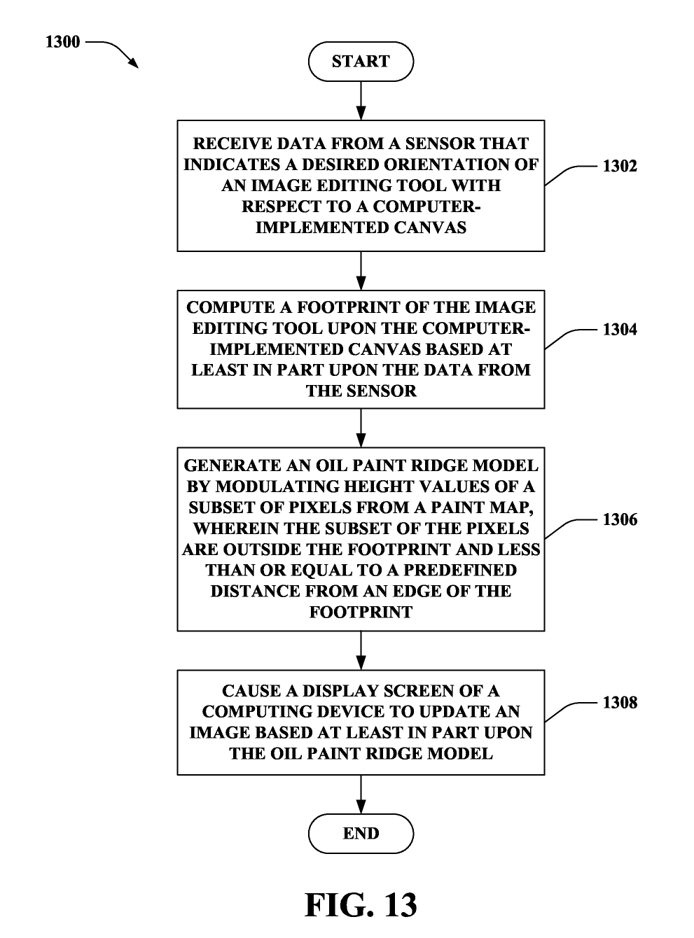

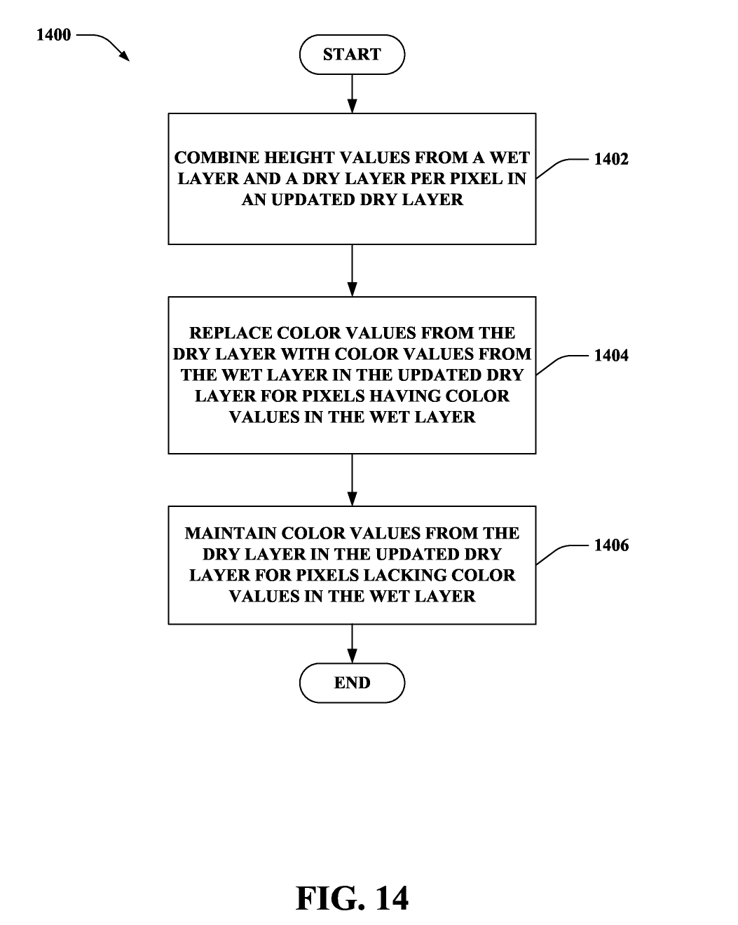

FIGS. 13-14 illustrate exemplary methodologies relating to simulating oil painting on a computer-implemented canvas. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

FIG. 13 illustrates a methodology 1300 of simulating oil painting. At 1302, data from a sensor that indicates a desired orientation of an image editing tool with respect to a computer-implemented canvas can be received. The computer-implemented canvas can include a paint map, and the paint map can include color values and height values of pixels representative of oil paint deposited on the computer-implemented canvas. At 1304, a footprint of the image editing tool upon the computer-implemented canvas can be computed based at least in part upon the data from the sensor. At 1306, an oil paint ridge model can be generated by modulating height values of a subset of the pixels from the paint map. The subset of the pixels can be outside the footprint and less than or equal to a predefined distance from an edge of the footprint. At 1308, a display screen of a computing device can be caused to update an image based at least in part upon the oil paint ridge model.

Turning to FIG. 14, illustrated is a methodology 1400 of drying oil paint deposited on a computer-implemented canvas by merging a wet layer into a dry layer of a paint map to create an updated dry layer. The computer-implemented canvas can include the paint map, and the paint map can include color values and height values of pixels representative of the oil paint deposited on the computer-implemented canvas.

At 1402, height values from the wet layer and the dry layer can be combined per pixel in the updated dry layer. At 1404, color values form the dry layer can be replaced with color values from the wet layer in the updated dry layer for pixels having color values in the wet layer. At 1406, color values from the dry layer can be maintained in the updated dry layer for pixels lacking color values in the wet layer.

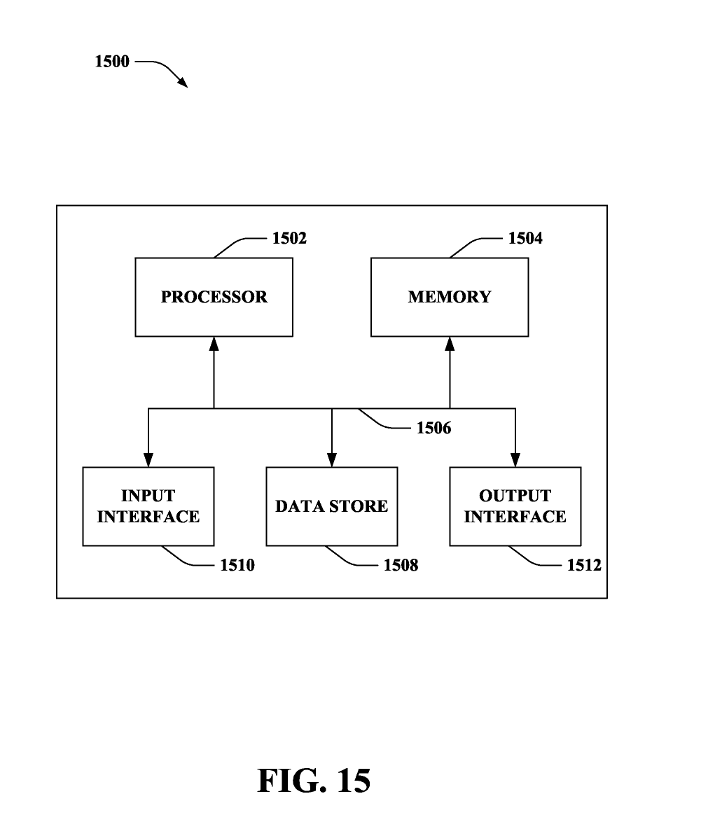

Referring now to FIG. 15, a high-level illustration of an exemplary computing device 1500 (e.g., the computing device 102 of FIG. 1) that can be used in accordance with the systems and methodologies disclosed herein is illustrated. For instance, the computing device 1500 may be used in a system that simulates oil painting on a computer-implemented canvas. The computing device 1500 includes at least one processor 1502 that executes instructions that are stored in a memory 1504. The instructions may be, for instance, instructions for implementing functionality described as being carried out by one or more components discussed above or instructions for implementing one or more of the methods described above. The processor 1502 may access the memory 1504 by way of a system bus 1506. In addition to storing executable instructions, the memory 1504 may also store a computer-implemented canvas, a paint map, a pickup map, a footprint, and so forth.

The computing device 1500 additionally includes a data store 1508 that is accessible by the processor 1502 by way of the system bus 1506. The data store 1508 may include executable instructions, a computer-implemented canvas, a paint map, a pickup map, a footprint, etc. The computing device 1500 also includes an input interface 1510 that allows external devices to communicate with the computing device 1500. For instance, the input interface 1510 may be used to receive instructions from an external computer device, from a user, etc. The computing device 1500 also includes an output interface 1512 that interfaces the computing device 1500 with one or more external devices. For example, the computing device 1500 may display text, images, etc. by way of the output interface 1512.

It is contemplated that the external devices that communicate with the computing device 1500 via the input interface 1510 and the output interface 1512 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1500 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1500 may be a distributed system. Thus, for instance, several devices may be in communication by way of a network connection and may collectively perform tasks described as being performed by the computing device 1500.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something.”

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A method of simulating oil painting, the method comprising the following computer-executable acts:
receiving data from a sensor that indicates a desired orientation of an image editing tool with respect to a computer-implemented canvas, wherein the computer-implemented canvas comprises a paint map, and wherein the paint map comprises color values and height values of pixels representative of oil paint deposited on the computer-implemented canvas;
computing a footprint of the image editing tool upon the computer-implemented canvas based at least in part upon the data from the sensor;
generating an oil paint ridge model by modulating the height values of a subset of the pixels from the paint map, wherein the subset of the pixels are outside the footprint and less than or equal to a predefined distance from an edge of the footprint; and
causing a display screen of a computing device to update an image based at least in part upon the oil paint ridge model.

2. The method of claim 1, wherein the predefined distance from the edge of the footprint is three pixels.

3. The method of claim 1, further comprising modulating the height values of the subset of the pixels from the paint map as a function of distance from the edge of the footprint.

4. The method of claim 3, further comprising:
increasing a first height value of a first pixel in the subset by a first increment, wherein the first pixel is at a distance of one pixel from the edge of the footprint;
increasing a second height value of a second pixel in the subset by a second increment, wherein the second pixel is at a distance of two pixels from the edge of the footprint, and wherein the first increment is greater than the second increment; and
increasing a third height value of a third pixel in the subset by a third increment, wherein the third pixel is at a distance of three pixels from the edge of the footprint, and wherein the second increment is greater than the third increment.

5. The method of claim 1, further comprising mixing a color value of a pixel in the subset of pixels from the paint map with a footprint color value, wherein the pixel is at a distance of one pixel from the edge of the footprint.

6. The method of claim 1, further comprising modulating a height value of a pixel that is outside the footprint if and only if the pixel is less than or equal to the predefined distance from the edge of the footprint in at least one of a first direction opposite a movement direction of the footprint, a second direction that is rotated clockwise by a predefined angle from the first direction, or a third direction that is rotated counterclockwise by the predefined angle from the first direction.

7. The method of claim 6, wherein the predefined angle is 45 degrees.

8. The method of claim 1, further comprising:
identifying a bounding box of the footprint;
determining whether pixels within the bounding box are outside the footprint and less than or equal to the predefined distance from the edge of the footprint, wherein the subset of the pixels for which the height values from the paint map are modulated are the pixels that are within the bounding box, outside the footprint, and less than or equal to the predefined distance from the edge of the footprint; and
inhibiting determining whether pixels outside the bounding box are outside the footprint and less than or equal to the predefined distance from the edge of the footprint.

9. The method of claim 1, computing the footprint of the image editing tool upon the computer-implemented canvas further based upon one or more of geometry of the image editing tool, a texture of the computer-implemented canvas, the height values of the pixels from the paint map, data received from the sensor that indicates a pressure applied to the image editing tool, or data received from the sensor that indicates movement of the image editing tool.

10. The method of claim 1, further comprising depositing disparate oil paint from the image editing tool onto the computer-implemented canvas by updating pixels from the paint map within the footprint based at least in part upon the color values and the height values of the pixels within the footprint and a pickup map, wherein the pickup map comprises color values and height values representative of the disparate oil paint on the image editing tool.

11. The method of claim 1, further comprising:
computing a second footprint of the image editing tool upon the computer-implemented canvas based at least in part upon the data from the sensor; and
depositing disparate oil paint from the image editing tool onto the computer-implemented canvas by updating pixels from the paint map within the footprint and the second footprint based at least in part upon the color values and the height values of the pixels within the footprint and the second footprint and a pickup map, wherein the pickup map comprises color values and height values representative of the disparate oil paint on the image editing tool.

12. The method of claim 1, wherein the paint map comprises a dry layer and a wet layer, wherein the wet layer is rendered above the dry layer on the display screen, the method further comprising:
drying the oil paint deposited on the computer-implemented canvas by merging the wet layer into the dry layer to create an updated dry layer, wherein merging the wet layer into the dry layer further comprises:
combining height values from the wet layer and the dry layer per pixel in the updated dry layer;
replacing color values from the dry layer with color values from the wet layer in the updated dry layer for pixels having color values in the wet layer; and
maintaining the color values from the dry layer in the updated dry layer for pixels lacking the color values in the wet layer.

13. The method of claim 12, further comprising:
depositing disparate oil paint from the image editing tool onto the computer-implemented canvas subsequent to drying the oil paint, wherein the disparate oil paint is deposited into the wet layer above the updated dry layer based at least in part upon the height values from the updated dry layer; and
causing the display screen of the computing device to update the image with the wet layer covering the updated dry layer.

14. A system that simulates oil painting, comprising:
a tool component that generates a model of an image editing tool, wherein the model of the image editing tool specifies geometry of the image editing tool;
an effector component that computes a footprint of the image editing tool upon a computer-implemented canvas, wherein the computer-implemented canvas comprises a paint map, wherein the paint map comprises color values and height values of pixels representative of oil paint deposited on the computer-implemented canvas, and wherein the effector component computes the footprint of the image editing tool upon the computer-implemented canvas based at least in part upon the geometry of the image editing tool, data received from a sensor that indicates a desired orientation of the image editing tool with respect to the computer-implemented canvas, and the height values of the pixels from the paint map; and
a paint component that updates the pixels from the paint map within the footprint based at least in part upon the color values and the height values of the pixels within the footprint and a pickup map, wherein the pixels are updated to deposit disparate oil paint from the image editing tool onto the computer-implemented canvas, and wherein the pickup map comprises color values and height values representative of the disparate oil paint on the image editing tool.

15. The system of claim 14, wherein the paint component further comprises a ridge creation component that generates an oil paint ridge model, wherein the ridge creation component further comprises:
an edge detection component that identifies a subset of the pixels that are outside the footprint and less than or equal to a predefined distance from an edge of the footprint; and
a modulation component that modulates the height values of the subset of the pixels from the paint map.

16. The system of claim 15, wherein the edge detection component determines respective distances of the subset of the pixels from the edge of the footprint, and wherein the modulation component modulates the height values of the subset of the pixels as a function of the respective distances from the edge of the footprint.

17. The system of claim 15, wherein the ridge creation component further comprises a movement track component that computes a movement direction of the footprint, wherein the modulation component modulates a height value of a pixel that is outside the footprint if and only if the pixel is less than or equal to the predefined distance from the edge of the footprint in at least one of a first direction opposite the movement direction of the footprint, a second direction that is rotated clockwise by a predefined angle from the first direction, or a third direction that is rotated counterclockwise by the predefined angle from the first direction.

18. The system of claim 14, wherein the paint map comprises a dry layer and a wet layer, wherein the wet layer is rendered above the dry layer on a display screen, and wherein the system further comprises a drying component that dries the oil paint deposited on the computer-implemented canvas by merging the wet layer into the dry layer to create an updated dry layer.

19. A computer-readable storage medium including computer-executable instructions that, when executed by a processor, cause the processor to perform acts including:
drying oil paint deposited on a computer-implemented canvas by merging a wet layer into a dry layer of a paint map to create an updated dry layer, wherein the computer-implemented canvas comprises the paint map, wherein the paint map comprises color values and height values of pixels representative of the oil paint deposited on the computer-implemented canvas, and wherein merging the wet layer into the dry layer further comprises:
combining height values from the wet layer and the dry layer per pixel in the updated dry layer;
replacing color values from the dry layer with color values from the wet layer in the updated dry layer for pixels having color values in the wet layer; and
maintaining color values from the dry layer in the updated dry layer for pixels lacking color values in the wet layer; and
causing a display screen of a computing device to render an image of the computer-implemented canvas with the wet layer above the dry layer.

20. The computer-readable storage medium of claim 19, wherein the computer-executable instructions, when executed by the processor, further cause the processor to perform acts comprising:
receiving data from a sensor that indicates a desired orientation of an image editing tool with respect to the computer-implemented canvas;
computing a footprint of the image editing tool upon the computer-implemented canvas based at least in part upon the data from the sensor;
generating an oil paint ridge model by modulating the height values of a subset of the pixels from the paint map, wherein the subset of the pixels are outside the footprint and less than or equal to a predefined distance from an edge of the footprint; and
causing the display screen of the computing device to update the image based at least in part upon the oil paint ridge model.
